(19) United States
(12) Patent Application Publication
(10) Pub. No.: US 2010/0157312 A1
(43) Pub. Date: Jun. 24, 2010

(54) METHOD OF RECONSTRUCTING A SURFACE TOPOLOGY OF AN OBJECT

(75) Inventors: Willem Dirk Van Amstel, Geldrop (NL); Konrad Krzysztof Szwedowicz, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/993,248

(22) PCT Filed: Jun. 27, 2006
(86) PCT No.: PCT/IB06/52118

§ 371 Date: Dec. 20, 2007

(30) Foreign Application Priority Data
Jun. 28, 2005 (EP) 05105733.9

(51) Int. Cl. G01B 11/25

(52) U.S. Cl. 356/511

(57) ABSTRACT

The invention relates to a method of reconstructing a surface topology of a surface (1) of an object (2). Conventional methods such as interferometry, or methods which acquire measurement values which represent slopes of the surface profile (slope values), show only a limited height resolution in the case of large flat objects such as wafers. In order to overcome this problem the surface of the object is sub-divided into smaller areas, and from each area slope values are obtained at optimum apparatus parameters. Then the areas are stitched together and the 3D topography is reconstructed.

The invention relates to the field of measuring the surfaces of three-dimensional (3D) objects and more particularly to nano topography of processed and unprocessed wafers, the surface determination of optical elements such as reference mirrors or aspheric lenses, and to free-forms in ophthalmic and optics industry.

Obtaining a true measurement and mapping of a three-dimensional surface was traditionally done by mechanical probes. These probes comprised a diamond needle or stylus which was moved with a high precision over the surface while being a mechanical contact with that said surface. The measured profiles of subsequent stylus scans are stitched together to form a 3D-topography. However, mechanical probes are very slow and are more suited for measuring profiles than for measuring the full three-dimensional topography. Moreover, in many applications a mechanical contact with the object is not allowed.

Generally known is the use of interferometry for the purpose of determining the three-dimensional topography of a surface. This widely used technique however faces a few basic limitations. One problem is that the measurement height-range is limited, as the fringe density is not allowed to be too high. Another disadvantage is that a lateral resolution is limited to the resolution of the sensor, which in most cases is a CCD-sensor.

In order to circumvent the problem of a limited lateral resolution mentioned in the last paragraph the lateral extension of a measurement field is often chosen to be small. This poses a problem when the surface of the object becomes larger than the measurement area. In this case the areas scanned by the interferometer need to be “stitched together” in order to reconstruct the whole surface. This stitching process is known to the man skilled in the art.

Applying stitching however requires that the areas, which are stitched together, are accurately arranged with respect to each other. As an example, the areas are not allowed to have a lateral offset with respect to each other. Furthermore, the areas should have the same rotational orientation. If these conditions are not met the 3D topography cannot be accurately reconstructed. This problem can be reduced to some degree by arranging an overlap between the areas. This however requires more computational resources and more time for carrying out the reconstruction. More importantly, even in theses cases the accuracy is unsatisfactory. As a consequence, a larger surface which has been stitched together will always show a limited height resolution.

Another possibility for obtaining a true measurement and mapping of a three-dimensional surface, e.g. of the surface of a silicon wafer, is the use of an apparatus performing slope measurements, and in particular optical slope measurements. In such an apparatus a sensor measures the slopes at predetermined locations on the surface. At this location the slope is determined in a first direction and in a second direction. The choice of these two directions is determined by the orientation of the slope sensor with respect to the 3D topography.

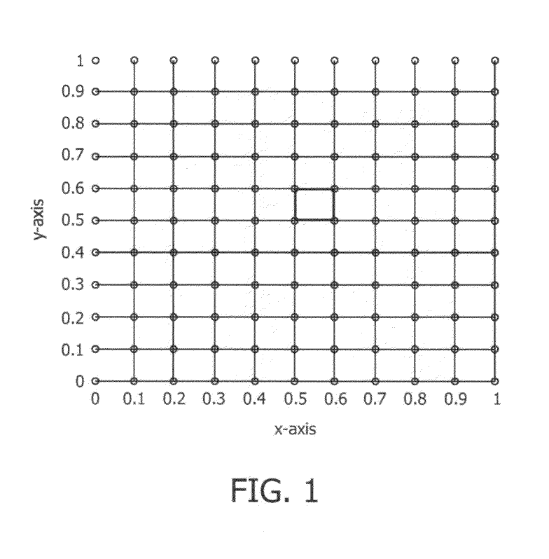

The measurements may be obtained using deflectometry, where light, e.g. light from a laser, is projected onto the surface and an angle of reflection is measured, providing information on the slope. The multitude of surface locations at which the slopes are determined are normally arranged in a regular pattern. This pattern can be described by a two-dimensional (2D) grid. FIG. 1 shows a typical equidistant measurement grid with measurements points along the rectangular coordinate lines.

Each grid point represents a predetermined surface location and includes the slope in a first direction and the slope in a second direction. For sake of simplicity the first direction and the second direction may be orthogonal to each other and define two axes, namely the x-axis and the y-axis, of a 3D Cartesian coordinate system. The z-axis is perpendicular to the x-axis and the y-axis. The height of a surface protrusion can then be plotted as the z-axis in this coordinate system. Other kinds of coordinate systems can however be used as well.

After measuring the slopes at the surface locations a mathematical algorithm is applied in order to reconstruct the surface. This algorithm may be based on carrying out a line integral along a path through the measurement grid. For example, by performing such a line integral along each “horizontal” path (i.e. each path parallel to one of the coordinate lines) the topography can be reconstructed. For each point along the path, the line integral uses the slope measured at the grid point in the direction of the path.

The reconstruction of a 3D topography from slope measurements becomes difficult in the case of large flat objects. These objects, e.g. silicon wafers having a diameter of 30 cm or even more, show a larger macroscopic bending in comparison to smaller-sized wafers. In this case the detector for measuring the slopes has to cope with a larger slope range than without the bending which in turn leads to a decreased height resolution.

US 2004/0145733 A1 discloses a method for reconstructing the 3D topography of a surface of an object with the help of slope measurements. In order to solve the problem mentioned in the last paragraph US 2004/0145733 A1 suggests to measure the surface of an object several times at different power settings of the illuminating optics, and to stitch the slope fields together. In other words the same object field is captured several times with different system parameters. Stitching together the measurement values then amounts to an increased dynamic range in the overlap region with respect to the slope values. As a consequence, a large object can be measured with a satisfactory height resolution. The disadvantage however is that several time-consuming measurements of the surface need to be performed and that the stitching procedure is rather complex.

It is an object of the present invention to provide a method of reconstructing the surface topology of the surface of an object which is fast and has a high height resolution in the case of large surfaces.

This object and other objects are solved by the features of the independent claims. Preferred embodiments of the invention are described by the features of the dependent claims. It should be emphasized that any reference signs in the claims shall not be construed as limiting the scope of the invention.

Accordingly, a method for reconstructing a surface topology of a surface of an object is suggested in which the surface is composed of at least two areas, namely a first area and at least a second area. The first area and the second area are associated with a first two-dimensional measurement grid and a second two-dimensional measurement grid respectively.

The first grid and the second grid are practically non-overlapping, i.e. the overlapping area is significantly smaller than the first area or the second area. Each grid point is associated with a surface location on the object. Each grid point includes information on this surface location, namely the slope at said surface location in a first direction and in a second direction. The method comprises the step of stitching together the two grids in order to obtain a single grid covering the whole object surface. In a subsequent step the surface topology is reconstructed from the slope information included in the grid points of the single grid.

The above-mentioned method thus divides the whole surface area into smaller parts, namely the first area and the at least second area. These areas do not overlap. The measurement grids associated with the areas partially overlap. However, it is sufficient to have an overlap consisting of a single grid point only. This means that the at least two grids are substantially non-overlapping.

A single set of measurement values is sufficient for each grid. This means that slope values need to be obtained only once for these grids. As the grids almost not overlap the whole surface of the object needs to be measured only once. Thus the work associated with the provision of the necessary slope data is kept to a minimum.

A single set of measurement values and a minimum overlap of the grids mean that the stitching process involves a minimum amount of data which makes the stitching process particularly fast and requires less computational resources.

After measuring slope values in each area, the areas—or correspondingly their associated grids—need to be arranged properly with respect with each other. The reason is that the spatial orientation of the x- and the y-axis in the first and the second area, along which the measurements have been carried out, is different. This difference is due to the fact that measurements in each area are performed with individually chosen apparatus parameters to ensure an optimal height resolution.

Mathematically, the above-mentioned arrangement is carried out by a transformation of the first grid into the second grid or vice versa. In other words a transformation of a first coordinate system into the other coordinate system is performed. For that purpose the relative position and/or the orientation of the coordinate systems must be identified in a first step. In a second step measurement values associated with the grid points are corrected, whereby this correction correlates with the grid transformation, i.e. the slope components undergo the same transformation. Finally, the areas are stitched together using the overlapped grid points as common grid points.

In the present invention slope values are stitched together, which is why this approach will be called “slope stitching” in this description. As slope values of substantially non-overlapping areas are stitched together this kind of stitching can also be called “lateral slope stitching”, as neighbouring areas are stitched together to obtain a single large area. US 2004/0145733 A1, which has been mentioned in the introductory part of the description, stitches slope values together. However, the areas to be stitched together by the method disclosed in US 2004/0145733 A1 strongly or completely overlap in order to increase the dynamic range in the overlap region. This is why this document does not perform lateral slope stitching. Furthermore, it is known in the prior art that height values, e.g. height values from interferometer measurements, can be stitched together which is called “height stitching” in this description.

An advantage of the method according to the invention is that slope stitching is far easier than height stitching, requires less complex algorithms and is thus faster. As explained above stitching together the areas requires a precise arrangement of the measurement grids with respect to each other. When carrying out height stitching six degrees of freedom need to be taken into account for a proper arrangement, namely three possible translations (in the x-, y- and z-direction in the case of a 3D Cartesian coordinate system), and three possible rotational misorientations due to rotations around the x-, y- and z-axis respectively. When carrying out slope stitching only three degrees of freedom need to be taken into account, namely the above-mentioned rotations. The reason is that lateral offsets of the grids have no effect on the slope values. In most practical cases however it is even sufficient to take only one rotation (the rotation one around the z-axis) into account. As a consequence, the calculations for stitching the grids together are strongly simplified and thus faster.

Furthermore, correcting for the above-mentioned degrees of freedom is easier in the case of slope stitching than in the case of height stitching. A rotational degree of freedom in the height domain requires a complex transformation of the grid points, and correspondingly of the slope values. In comparison, when a rotational degree of freedom is corrected for in the case of slope stitching only a constant value, a slope offset, has to be subtracted from or added to the slopes of the neighbouring area.

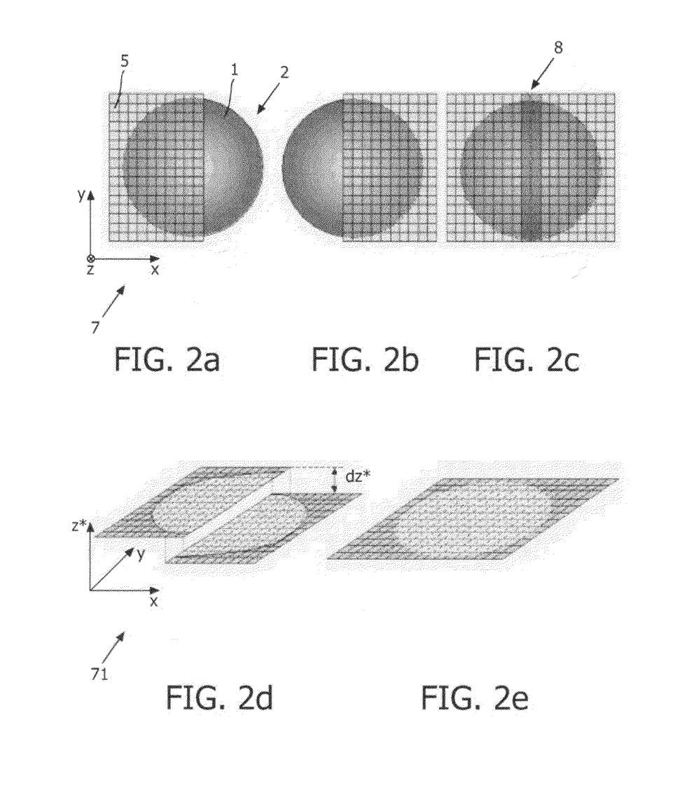

This is illustrated in FIG. 2a-e. FIG. 2a shows the circular surface 1 of an object 2 of which the 3D topography should be reconstructed. The measurement area, represented by the first grid 5, does not cover the whole surface 1. The grid 5 spans the xy-plane of a coordinate system 7, the z-axis (height axis) is perpendicular to the xy-plane. In this arrangement a first slope measurement is carried out. Then the grid 5 and the object 2 are moved with respect to each other as indicated in FIG. 2b, such that a second measurement is carried out. FIG. 2c illustrates the net result of the two measurements. In total, the whole surface 1 has been scanned whereby two measurements have been carried out in the overlap region 8. The size of the overlap region 8 is exaggerated for illustrative purposes.

In FIG. 2d the slope measured in the x-direction is plotted versus x and y, i.e. versus the measurement location. The central offset dz* exists because the first coordinate system is rotated around the z-axis when compared to the second axis. It should be emphasized that in FIG. 2d-e the axis perpendicular to the xy-plane is not the z-axis, but represents the z-component z* of the slope as indicated by the coordinate z* at coordinate system 7′.

The z*-offset can be estimated from the pixels in the overlap region 8. In principle a single overlapped pixel is sufficient to estimate the offset. The slope offset can be estimated more accurately from a larger number of overlapped pixels, either by calculating and comparing the mean slope in the overlap region 8, or by using a least square approach, or by other “error minimizing” techniques known to the man skilled in the art. The result is shown in FIG. 2e.

Another advantage of the present invention is that each area can be measured with optimum apparatus parameters and thus with an optimum dynamic slope range. This avoids the problem of an reduced height accuracy in the case of large bended surfaces.

The method described above can be applied to the measurement values of slope measurement apparatus such as deflectometers, wave front sensors such as Shack-Hartman sensors, shearing interferometers or the like. It can be applied to 2D slope measurements as well as to one-dimensional (1D)(profile) slope measurements. Typically, such measurement values are described by a 1D or 2D array of pixels.

According in a preferred embodiment the method is carried out that in the case that the transformation comprises a rotation around the x-axis of the first coordinate system only slope components in the y-direction are transformed correspondingly. Symmetrically, in the case that the transformation comprises a rotation around the y-axis of the first coordinate system only slope components in the x-direction are transformed correspondingly. This approach is possible because a rotation around the x-axis does not effect slope values in the y-direction, whereas a rotation around the y-axis does not effect slope values in the x-direction. In this case the computational burden is decreased and the reconstruction of the 3D topography becomes faster.

According in a preferred embodiment the method is carried out that in the case that the transformation comprises a rotation around the x- and/or y-axis a constant offset is added to the z-components of the slope. This shows that stitching of slope data is easy to carry out.

According in a preferred embodiment the method is carried out by a computer program which can be stored on a computer readable medium such as a CD or a DVD. As a matter of fact, the computer program can also be transmitted by means of a sequence of electric signals over a network such as a LAN or the interne. The program can run on a stand-alone personal computer, or can be an integral part of the apparatus for carrying out slope measurements.

According in a preferred embodiment the method is carried out in such a way that prior to stitching together the at least two grids the slopes at the grid points of the first grid and the second grid are determined. Referring to the last paragraph this embodiment reflects the way in which an apparatus for carrying out slope measurements is operated when it comprises the above-mentioned computer program product.

These and other aspects of the invention will be apparent from and elucidated with reference to the embodiments described thereafter. It should be emphasized that the use of reference signs shall not be construed as limiting the scope of the invention.

FIG. 1 shows a 2D measurement grid,

FIG. 2 illustrates stitching of slope data,

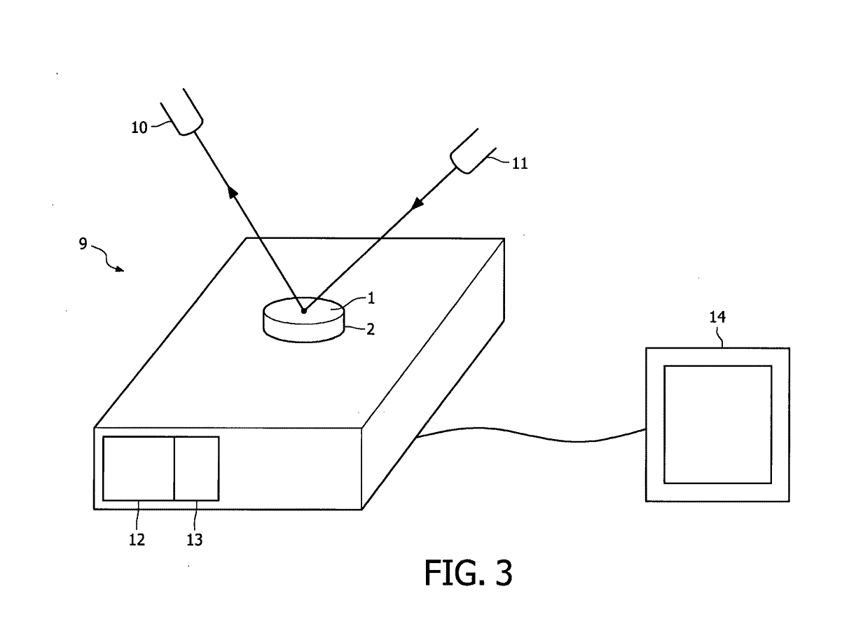

FIG. 3 shows an apparatus for carrying out slope measurements,

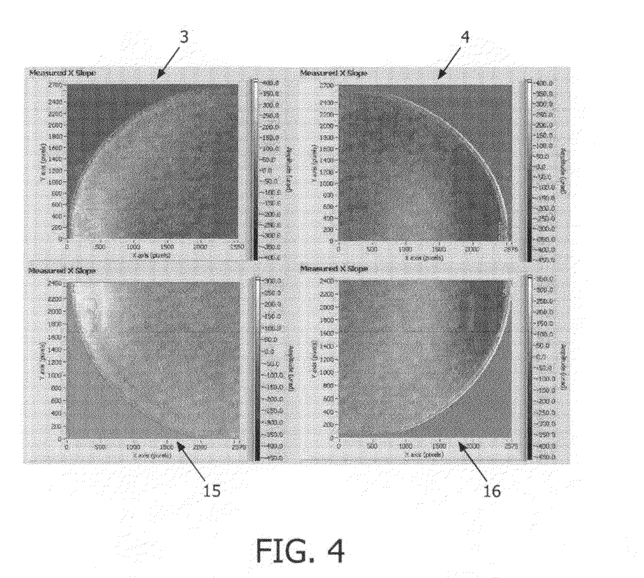

FIG. 4 shows the slopes measured in the x-direction,

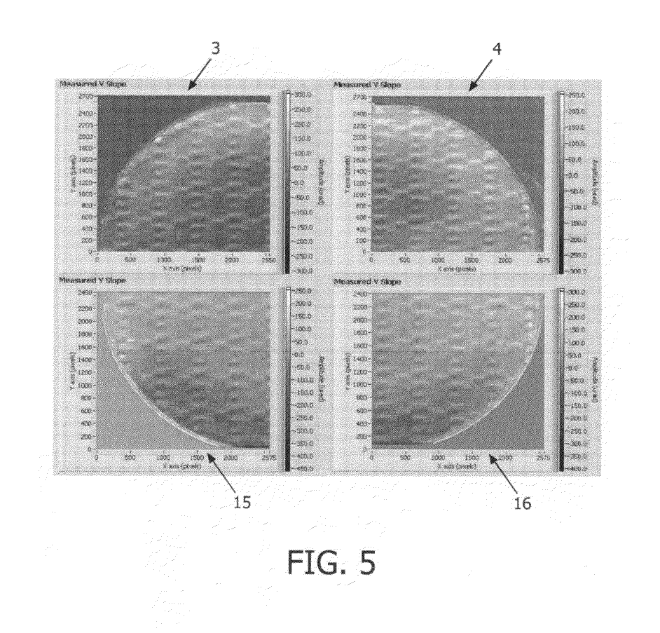

FIG. 5 shows the slopes measured in the y-direction,

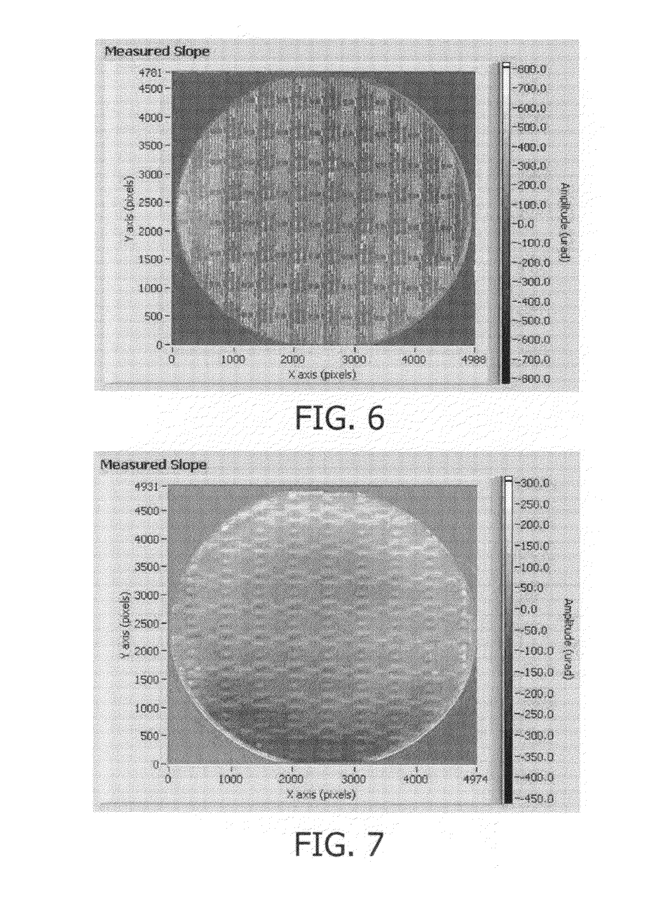

FIG. 6 shows a slope image of the object with slopes in the x-direction,

FIG. 7 shows a slope image of the object with slopes in the y-direction,

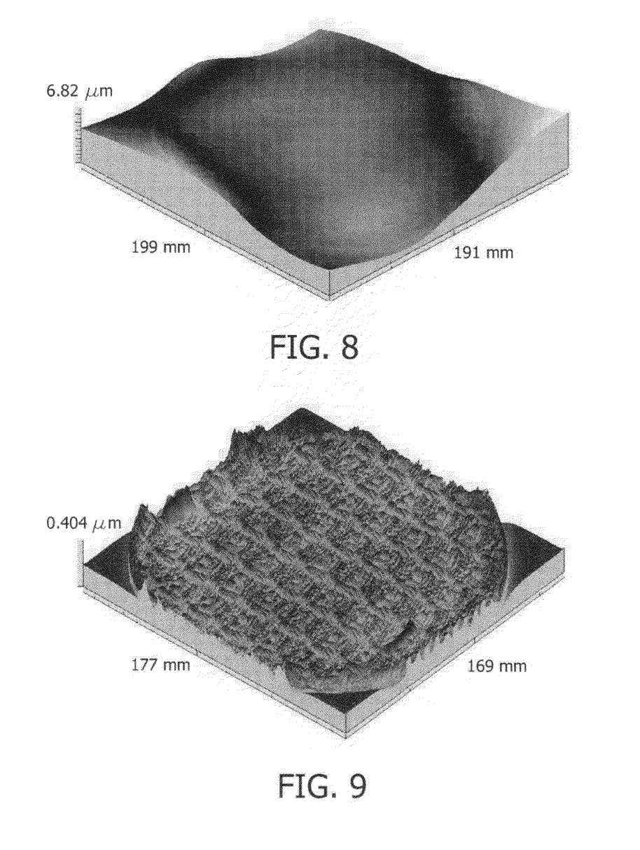

FIG. 8 shows a free-form of the wafer,

FIG. 9 shows the nano-topography of the wafer.

### DETAILED DESCRIPTION OF THE DRAWINGS AND OF THE PREFERRED EMBODIMENTS

FIG. 3 shows schematically an apparatus 9 for reconstructing the surface topography of a surface of an object according to the invention. In this embodiment the apparatus is an experimental setup of a 3D-deflectometer. It has a slope resolution of 1 grad, a slope range of 2 mrad, a height resolution of 1 nm per 20 mm. The sampling distance was 40 μm, the measurement area 110×500 mm. The deflectometer used a linear scanline having a length of 110 mm.

The deflectometer 9 contained a sensor 10, namely a Shack-Hartmann sensor for detecting light from the surface 1 of an object 2 as indicated by the arrow. The light originated from a laser 11.

The object 2 was a patterned (processed) Si-wafer having a diameter of 200 mm A focal spot on the surface 1 of the wafer 2 was circular and had a diameter of 110 micrometers. The control unit 12 insured a step wised scaling of the surface by means of a sensor 10. The acquired data were transferred to computational entity 13 and stored on a storage means, namely a hard disc. The results can be viewed on display 14.

The measurement area exceeded the object area such that the object was measured sequentially by four measurements in the areas 2,3,15 and 16. As the 3D-deflectometer 9 was not designed for slope stitching it only comprised a single translation axis. The cross-translation was thus carried out manually. As will be seen from the results presented below this means that the method is extremely robust.

FIG. 4 shows the measured slopes in the x-direction, whereas FIG. 5 shows the corresponding slopes in the y-direction. Between each measurement the wafer was tilt-adjusted for rotations around the x-axis and the y-axis to guarantee an optimum slope range of the 3D-deflectometer 9 in the four areas 3,4,15 and 16.

Next the data were processed. As the wafer 2 had been moved by hand during the sequential measurements, this rather primitive shift of the object affected all six degrees of freedom as far as the grids are concerned. The slope data were used to indicate the relative positions of the measured areas. For that purpose the slope information from the overlap region was analyzed and the images were shifted such that the slope structures matched each other. This operation was done by an in-house made LabView program.

For sake of simplicity a rotation of the wafer 2 around the z-axis was neglected which provides the largest error into the stitched data. Then the slope offset between the areas were calculated from the mean slope values of the overlapped pixels and were corrected. Finally, the areas were stitched together. The result is shown in FIGS. 6 and 7.

FIG. 6 shows the slope image of the wafer 2 with slopes in the x-direction, whereas FIG. 7 shows the corresponding slope image with slopes in the y-direction. Quite remarkable is that the slope range was 1.8 mrad, which is almost the maximum of the deflectometers slope range.

Eventually the slope-stitched data had been processed to acquire the 3D topography of the wafer. An integration method was used which, neatly, minimized the stitching errors. The result is shown in FIG. 8, namely the free-form of the wafer which includes the global low-frequency structure. To get the nano-topography a usual Gaussian filtering of the free-form was carried out, the result of which is shown in FIG. 9. Although the scale range is about 400 nm the topography is reconstructed very accurately. Stitching errors can not be recognized.

### LIST OF REFERENCE NUMERALS

| | |
|---|---|
| 01 | surface |
| 02 | object |
| 03 | first area |
| 04 | second area |
| 05 | first grid |
| 06 | second grid |
| 07 | coordinate system |
| 08 | overlap region |
| 09 | 3D-deflectometer |
| 10 | sensor |
| 11 | laser |
| 12 | control unit |
| 13 | computational entity |
| 14 | display |
| 15 | third area |
| 16 | fourth area |

1. Method of reconstructing a surface topology of a surface (1) of an object (2),
whereby the surface is composed of a first area (3) and at least a second area (4),
whereby the first area and the second area are associated with a first 2-dimensional measurement grid (5) and a second 2-dimensional measurement grid (6) respectively,
whereby the first grid and the second grid are substantially non-overlapping grids,
whereby each grid point includes information on a location of the surface, said information being the slope at said location in a first direction and the slope at said location in a second direction,
the method comprising the steps of
a) stitching together the at least two grids in order to obtain a single grid covering the whole surface
b) reconstructing the surface from the slope information included in the grid points of the single grid.

2. Method according to claim 1, characterized in that each grid defines a xy-plane of a Cartesian coordinate system with a z-axis being perpendicular to the xy-plane, and that stitching together the two grids includes transforming one coordinate system into the other coordinate system.

3. Method according to claim 2, characterized in that in the case that the transformation comprises a rotation around the x-axis of the first coordinate system only slope components in the y-direction are transformed correspondingly.

4. Method according to claim 2, characterized in that in the case that the transformation comprises a rotation around the y-axis of the first coordinate system only slope components in the x-direction are transformed correspondingly.

5. Method according to claim 3, characterized in that that in the case that the transformation comprises a rotation around the x- and/or y-axis a constant offset is added to the z-components of the slope.

6. Method according to claim 1, characterized in that the method is carried out by a computer program.

7. Method according to claim 1, characterized in that prior to stitching together the at least two grids the slopes at the grid points of the first grid and the second grid are determined.

8. Computer program product comprising a computer readable medium, having thereon computer program code means, when said program is loaded, to make the computer executable for the method according to claim 1.

9. System for reconstructing a surface of an object, comprising
a) an input for receiving a first two-dimensional measurement grid (5) and at least a second two-dimensional measurement grid (6), the first grid and the second grid being associated with a first area (3) and a second area (4) of the surface (1) of an object (2) respectively, the two grids substantially not overlapping each other, each grid point including information on a location of the surface, said information being the slope at said location in a first direction and the slope at said location in a second direction,
b) a processor for, under control of a program, stitching together the two grids to obtain a single grid, and for reconstructing the surface from the slope information included in the grid points of the single grid.

10. System according to claim 9, characterized in that the system comprises a measurement unit for determining the information included at the grid points of the first grid and of the second grid.

11. System according to claim 10, characterized in that the system comprises a deflectrometry measurement unit.
